(19) United States
(12) Patent Application Publication
(10) Pub. No.: US 2014/0021001 A1
(43) Pub. Date: Jan. 23, 2014

(54) TORQUE TRANSMISSION DEVICE

(71) Applicant: Herbert Steinwender, Haselsdorf-Tobelbad (AT)

(72) Inventor: Herbert Steinwender, Haselsdorf-Tobelbad (AT)

(73) Assignee: MAGNA POWERTRAIN AG & CO KG, Lannach (AT)

(21) Appl. No.: 13/823,807

(22) PCT Filed: Aug. 29, 2011
(86) PCT No.: PCT/EP2011/004332

§ 371 Date: Sep. 6, 2013

(30) Foreign Application Priority Data
Sep. 16, 2010 (DE) 10 2010 045 721.3

(51) Int. Cl. F16D 13/52; F16D 27/00

(52) U.S. Cl. CPC F16D 13/52; F16D 27/00
USPC 192/70.11; 192/82 R; 192/84.9; 192/93 A

(57) ABSTRACT

A torque transmission device for the transmission of torque between a first component and a second component which are mounted such that they can rotate about a common rotational axis. The torque transmission device includes a clutch configured to actuate in the axial direction and an actuation unit with a converter device and an actuating device. The converter device includes at least one axially movable first converter element and a second converter element assigned to the second component. The converter elements are configured such that relative rotation between the first and the second converter elements is converted into an axial movement of the first converter element to actuate the clutch. The actuating device is configured to generate selective coupling action between the first converter element and a structural element of the clutch.

### CROSS-REFERENCE TO RELATED APPLICATIONS

The present application is a National Stage application of PCT International Application No. PCT/EP2011/004332 (filed on Aug. 29, 2011), under 35 U.S.C. §371, which claims priority to German Patent Application No. DE 10 2010 045 721.3 (filed on Sep. 16, 2010), which are each hereby incorporated by reference in their complete respective entireties.

### TECHNICAL FIELD

The present invention relates to a torque transmission device for the transmission of torque between a first and a second component which are mounted such that they can rotate about a common rotational axis.

### BACKGROUND

Torque transmission devices of this type often have a clutch which can be actuated in the axial direction and an actuation unit with a converter device and an actuating device. Here, the converter device serves to convert a movement which is produced by the actuating device into a movement which is suitable for actuating the clutch. It is of great significance in torque transmission devices that they have a reliable and efficient method of operation and, in particular, that the required torque can be transmitted to the desired extent. Moreover, they have to be compact and simple to cool.

### SUMMARY

It is therefore an object of the present invention to provide a torque transmission device of the abovementioned type which satisfies the abovementioned requirements and which is at the same time inexpensive.

This object is achieved by a torque transmission device for the transmission of torque between a first component and a second component which are mounted such that they can rotate about a common rotational axis, comprising a clutch which can be actuated in the axial direction and an actuation unit with a converter device and an actuating device, the converter device comprising at least one axially movable first converter element and a second converter element which is assigned to the second component, which converter elements are arranged such that they can be rotated relative to one another and are configured in such a way that a relative rotation between the first and the second converter element can be converted into an axial movement of the first converter element for actuating the clutch, the actuating device being configured in such a way that a coupling action can be generated selectively between the first converter element and a structural element of the clutch, which structural element is connected fixedly to the first component so as to rotate with it, in order to bring about a relative rotation of the converter elements with respect to one another.

According to the invention, the converter device of the actuation unit comprises at least one axially movable first converter element and a second converter element which is assigned to the second component. The converter elements are arranged such that they can be rotated relative to one another and are configured in such a way that a relative rotation between the first and the second converter element can be converted into an axial movement of the first converter element for actuating the clutch. The actuating device is configured in such a way that a coupling action can be generated selectively between the first converter element and a structural element of the clutch, which structural element is connected fixedly to the first component so as to rotate with it, in order to bring about a relative rotation of the converter elements with respect to one another.

In other words, it is provided that the converter device utilizes a relative rotation of the two converter elements, in order to drive the first converter element to perform an axial movement which serves to actuate the clutch. The actuating device produces a coupling action between a structural element which is connected to the first component and the first converter element. Upon actuation of the actuating device, a part of the converter device is therefore ultimately coupled to the first component, in order to utilize a rotational speed difference, present in a non-actuated state of the torque transmission device, between the first and the second component to actuate the converter device. As a result of the coupling action, a rotationally fixed connection does not necessarily have to be produced. In many cases, it is sufficient and even preferred if merely a “slipping” coupling action is produced between the structural element and the first converter element by the actuating device.

For example, in the case of a rotation of the first component and a second component which is at rest, the first converter element is accelerated, upon activation of the actuating device, by way of the coupling action with the structural element which is connected fixedly to the first component so as to rotate with it, whereas the second converter element which is assigned to the second component does not perform a rotational movement. On account of the coupling action with the first component via the structural element, the first converter element rotates relative to the second converter element, as a result of which an axial movement of the first converter element is generated, which axial movement actuates the clutch.

It goes without saying that the torque transmission device operates in an analogous way if the first component does not move initially and the second component rotates or if the two components rotate at different rotational speeds. It is essential merely that there is any rotational speed difference at all between the two components. However, this situation exists as a rule if an actuation of the torque transmission device is requested, since no torque transmission is required if the rotational speeds of the two components are identical.

The utilization of the rotational speed difference which is present in any case before coupling of the components to generate the axial actuating force of the clutch makes high efficiency of the torque transmission device possible. For example, the converter device can be designed in such a way that the characteristic of the axial movement of the first converter element is a function of the rotational speed difference between the first and the second component. Furthermore, it is advantageous that, in addition to the actuating device and the converter device, no further structural units are necessary to produce the functional capability of the actuation unit. The latter can therefore be of compact and robust design and can be produced inexpensively. In addition, the compact overall design simplifies the dissipation of the waste heat which is generated during operation of the torque transmission device.

In accordance with one advantageous embodiment, the actuating device comprises an electromagnet which is configured and arranged in such a way that a magnetic coupling action can be generated between the first converter element and the structural element which is connected fixedly to the first component so as to rotate with it. An electromagnet is a robust and inexpensive component which in addition reacts rapidly to corresponding request signals, with the result that the torque transmission device can be actuated rapidly overall. Moreover, electromagnets can be controlled in a simple way, with the result that the torque which is transmitted via the torque transmission device can also be controlled satisfactorily.

The electromagnet preferably comprises a coil which is arranged coaxially with respect to the first and the second structural element.

A robust and structurally simple embodiment of the torque transmission device provides that the second converter element is connected to the second component such that it is fixed axially and fixed so as to rotate with the latter. The second converter element can therefore serve as axial support for the axial movement of the first converter element. Since the second converter element is connected fixedly to the second component so as to rotate with it, it is already sufficient for the generation of a relative rotation of the two converter elements, moreover, to couple the first converter element selectively to the structural element.

The first converter element can be arranged such that it can be rotated relative to the first component and to the second component. The rotation, which is possible at least within defined limits, of the first converter element relative to the two components ensures satisfactory decoupling of the two components in a non-actuated state of the torque transmission device, which leads to improvements in efficiency.

The converter elements preferably form a ramp mechanism which comprises, in particular, at least one rolling body which is arranged between the converter elements. The converter elements can in each case have at least one V-shaped or U-shaped groove, in which the rolling body is arranged, in order to guide the latter reliably. A converter device which is provided with a ramp mechanism ensures a reliable conversion of a relative rotational movement of the two components into an axial movement.

If the coupling action between the structural element and the first converter element is generated, for example, by virtue of the fact that the two stated components are pressed against one another, a reinforcement of the initially provided pressing force can be brought about with a suitable refinement of the ramp mechanism. As a result of the initially, for example, comparatively weak coupling action between the structural element and the first converter element, a first rotation of the first converter element relative to the second converter element is generated, as has already been described in the preceding text. The ramp mechanism converts this rotation into an axial movement which, in the case of a suitable relative arrangement and design of the structural element and of the first converter element, leads to boosting of the coupling action which acts between them. This boosting coupling action in turn brings about more pronounced “driving” of the first converter element by the structural element which is connected fixedly to the first component so as to rotate with it. As a result, the relative rotation between the first and the second converter element is increased, which in turn leads to a further axial movement of the first converter element and therefore to boosting of the above-described coupling action. The automatic boosting of the initially applied actuation force by way of a suitable design of the actuation unit is called self-energizing.

More efficient heat dissipation and a more compact overall design are achieved if the first component surrounds the converter device and/or the actuating device at least partially and, in particular, covers the actuating device completely in the axial direction. An additional housing to protect the converter device and/or the actuating device is then not necessary.

As an alternative or in addition, it can be provided that the first converter element has a recess which receives the actuating device at least partially, in particular completely, in order to protect it and also in order to achieve an efficient method of operation of the actuation unit on account of the compact overall design.

The clutch can be an, in particular dry-running, multiple disk clutch.

In accordance with one embodiment, the structural element comprises a first frictional face which interacts with the first converter element and a second frictional face which lies opposite and interacts with a multiple disk assembly of the multiple disk clutch, in order to improve the coupling action between the structural element and the first converter element upon actuation of the torque transmission device.

The structural element which is connected fixedly to the first component so as to rotate with it is preferably a disk of the multiple disk clutch, that is to say a coupling action is produced between a disk of the multiple disk clutch and the first converter element in order to actuate the torque transmission device. The structural element is, in particular, a “pilot disk” which is configured to be somewhat more robust than the remaining disks of the multiple disk assembly, forms a type of link between the first converter element and the multiple disk assembly, and which is configured to be correspondingly more stable in order to absorb the actuation forces which act on it. If a magnetic coupling action is provided between the pilot disk and the first converter element, it proves advantageous to produce the pilot disk and/or the first converter element from highly magnetically permeable material. This facilitates the routing of magnetic flux lines through the stated components and therefore improves the coupling action which acts between them upon actuation of the torque transmission device. Improved field flux routing is also assisted by a design of the stated components which is comparatively stable in cross section.

The first component is preferably a clutch basket of the clutch.

Further embodiments of the invention are specified in the description, the subclaims and the drawings.

### DRAWINGS

In the following text, the invention will be explained using advantageous embodiments purely by way of example with reference to the appended drawings, in which:

FIG. 1 illustrates a cross section through a diagrammatically illustrated embodiment of the torque transmission device in accordance with the invention.

FIG. 2 illustrates the embodiment which is illustrated in FIG. 1, in an actuated state.

FIG. 3 illustrates an outline sketch for the method of operation of the ramp mechanism of the converter device, and

FIG. 4 illustrates a sectional view of one embodiment of the torque transmission device in accordance with the invention with a wet-running multiple disk clutch.

### DESCRIPTION

FIG. 1 illustrates a torque transmission device 10 which comprises a multiple disk clutch 12 for the transmission of a torque from a shaft 14 to a flange 16, and vice versa.

The flange 16 is configured in one piece with a clutch basket section 18a of a clutch basket 18. Outer disks 20 which can be displaced axially with the aid of a spline system 24 in relation to a rotational axis R which is common to the flange 16 and the shaft 14 and are connected fixedly to the clutch basket section 18a so as to rotate with it are arranged on the clutch basket section 18a. The outer disks 20 are arranged in an alternating manner with inner disks 22 which are in turn connected by means of a spline system 24′ to the shaft 14 such that they can be displaced axially but are fixed to said shaft 14 so as to rotate with it.

A coupling action can be produced between the shaft 14 and the flange 16 in a manner which is known per se, by a multiple disk assembly which is formed from the disks 20, 22 being pressed together. On account of the frictional forces which then act between the disks 20, 22, a torque transmission takes place between the rotating components 14, 16, which torque transmission is dependent, inter alia, on the force which loads the multiple disk assembly.

In order to actuate the multiple disk clutch 12, an actuation unit 26 is provided with a converter device 28 which converts a rotational speed difference between the shaft 14 and the flange 16 into an axial movement which loads the multiple disk assembly. The converter device 28 comprises a converter element 30 which is connected to the shaft 14 such that it is fixed axially and fixed so as to rotate with the latter. Said converter element 30 interacts via a plurality of rolling bodies 32 with a further converter element 34 which, however, in contrast to the converter element 30, is arranged such that it can be rotated and moved axially in relation to the shaft 14. Furthermore, the converter element 34 is also rotatable and axially movable in relation to the flange 16 and the clutch basket section 18a which is configured integrally with it.

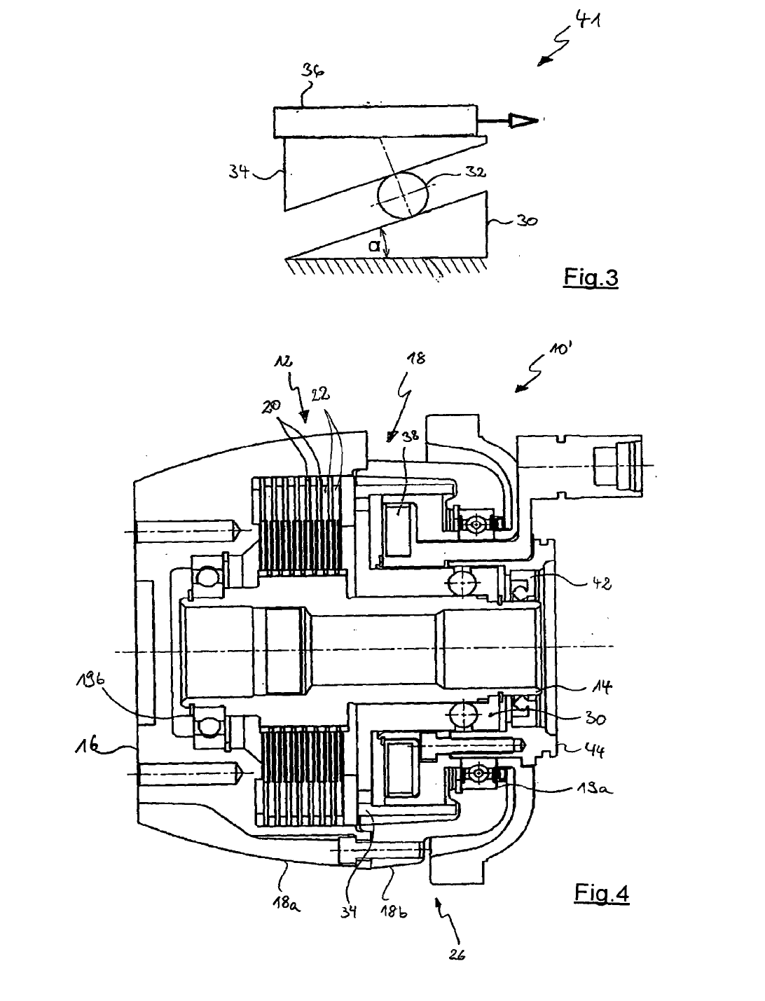

Together with the rolling bodies 32 which are arranged distributed around the shaft 14 in the circumferential direction and in V-shaped grooves 32a for guidance, the converter elements 30, 34 form a ramp mechanism of a type which is known per se, which ramp mechanism will also be explained in detail in the following text using FIG. 3. A relative rotation of the converter element 34 with respect to the converter element 30 leads to the converter element 34 being pressed to the left against a pilot disk 36 which, like the outer disks 20, is connected to the clutch basket section 18a in an axially displaceable and fixed manner so as to rotate with the latter. The axial loading of the pilot disk 36 by the converter element 34 leads to the multiple disk assembly being pressed together, which leads in the above-described way to a torque transmission between the shaft 14 and the flange 16. It goes without saying that the pilot disk 36 which is of more stable configuration than the outer disks 20 can in principle be structurally identical with the outer disks 20 if the performance requirements of the torque transmission device 10 allow.

A relative rotation of the converter elements 30, 34 is generated by a coupling action being produced between the converter element 34 and the pilot disk 36, as a result of which the converter element 34 is ultimately coupled to the clutch basket 18 in a manner which is effective for drive purposes but is not necessarily fixed so that they rotate together, and said converter element 34 is therefore activated to perform a rotational movement. Since a coupling action between the flange 16, which is connected, for example, to a further shaft (not shown), and the shaft 14 is then required merely if there is a rotational speed difference between the two stated components, this means that a coupling action of the converter element 34 with the clutch basket 18 leads to a movement of the converter element 34 relative to the converter element 30 which is connected fixedly to the shaft 14 so as to rotate with it. On account of the ramp mechanism, this rotation leads to an axial movement of the converter element 34 which is pressed more strongly against the pilot disk 36 as a result and therefore compresses the multiple disk assembly of the clutch 12 more strongly, which multiple disk assembly is supported axially on the flange 16. The stronger pressing force of the converter element 34 leads to an increased friction between the converter element 34 and the pilot disk 36, which in turn leads to a stronger coupling of the converter element 34 to the rotational movement of the clutch basket 18. In order to reinforce this effect, the coupling action between the converter element 34 and the pilot disk 36 can be improved by way of corresponding friction linings. As a result of the boosted coupling of the converter element 34 to the rotational movement of the clutch basket 18, the converter element 34 is rotated further with respect to the converter element 30, which in turn leads to a boosted pressing force.

In other words, a self-energizing action is generated by the utilization of the rotational speed difference between the flange 16 and the shaft 14 in order to generate the force which loads the multiple disk assembly with the aid of the ramp mechanism, which self-energizing action exceeds the force which was initially applied for the coupling action between the converter element 34 and the pilot disk 36.

The actuation force which is required at the beginning of the actuation of the clutch 12 is provided by an electromagnet 38 which is arranged coaxially with respect to the shaft 14, the flange 16 and the converter elements 30, 34 and the disks 20, 22. If current is applied to the electromagnet 38, a magnetization is induced in the converter element 34, which magnetization, together with a corresponding induced magnetization of the pilot disk 36, generates a magnetic coupling action which is sufficient to couple the converter element 34 to the pilot disk 36 so strongly that a relative rotation with respect to the converter element 30 is brought about, which relative rotation initiates the above-described self-energizing action. It goes without saying that the converter element 34 and/or the pilot disk 36 are manufactured from highly magnetically permeable material in order to produce an efficient coupling action, since a comparatively great magnetization is induced by a given magnetic field in the case of materials of this type.

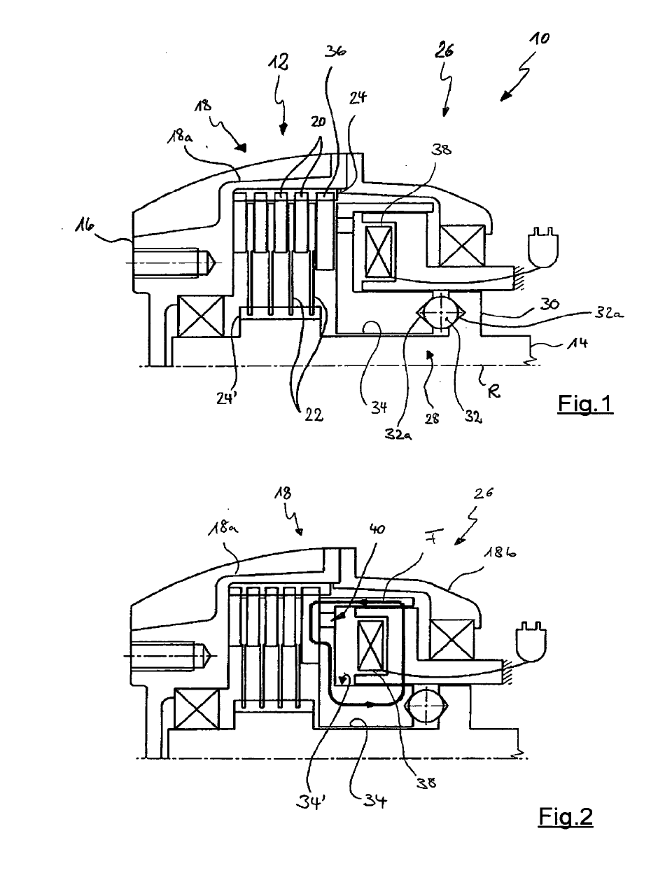

A magnetic flux F which is generated by the induced magnetization and penetrates the converter element 34 and the pilot disk 36 is illustrated qualitatively in FIG. 2. In order to prevent a magnetic “short circuit” which would weaken a coupling action between the pilot disk 36 and the converter element 34, recesses 40 are provided in the converter element 34, which recesses 40 force the magnetic flux F to exit the converter element 34 and enter the pilot disk 30.

In order to protect the actuation unit 26, the clutch basket 18 has a housing section 18b which is connected fixedly to the section 18a so as to rotate with it and surrounds the actuation unit 26 substantially completely. Independently of this, but likewise assisting the compactness and robustness of the torque transmission device 10 is the aspect that the electromagnet 38 is arranged in a recess 34′ of the converter element 34. As a result of the spatial closeness of the electromagnet 38 to the converter element 34 and the pilot disk 36, the magnetic field which is generated by the electromagnet 38 can act particularly efficiently on the converter element 34 and the pilot disk 36.

FIG. 3 outlines the embodiment of a ramp mechanism 41 of the converter device 28 in diagrammatic form, the lower wedge corresponding to the converter element 30 and the upper wedge symbolizing the converter element 34. The rolling body 32, a ball here, is arranged between the converter elements 30, 34. Since the converter element 30 is arranged fixedly, a relative movement of the converter element 34 to the right, which corresponds to a relative rotation of the two converter elements 30, 34, leads to an axial movement of the converter element 34 (corresponds to a movement upward in FIG. 3). The initial movement of the converter element 34 to the right is brought about by the above-described magnetic coupling action which is generated by the electromagnet 38. Here, the converter element 34 is “carried along” with the pilot disk 36 which is rotating more rapidly, as a result of which the above-described self-energizing action is initiated. It goes without saying that the self-energizing action is, inter alia, a function of a coefficient of friction between the pilot disk 36 and the converter element 34 and the gradient α of the ramp mechanism 41. The greater the stated coefficient of friction and/or the smaller the gradient α, the greater the self-energizing effect of the actuation unit 26.

FIG. 4 illustrates a torque transmission device 10′ with wet-running disks 20, 22. In the case of a “wet” clutch 12 of this type, the coefficients of friction which are active in its interior are relatively constant on account of comparatively low wear. Moreover, the dissipation of the frictional heat which occurs during operation is ensured by a lubricant which fills the interior of the torque transmission device 10′. The dissipation of heat is assisted by the advantageously compact embodiment of the clutch basket 18 which, as described, encloses essential parts of the torque transmission device 10′ in the manner of a housing.

In order to prevent a discharge of lubricant from the region of the clutch 12 and the actuation unit 26, a sealing element 42 is provided. Moreover, a bearing 19a between the housing section 18b and a flange 44 which carries the electromagnet 38 is configured as a bearing which is sealed on one side.

It goes without saying that the functional principle, described in detail multiple times in the preceding text, of the torque transmission device 10, 10′ can also be readily realized with a “dry” clutch. A bearing 19b which mounts the shaft 14 in the flange 16 would then be configured as a sealed, grease-lubricated bearing. The same applies to the bearing 19a. In return, the sealing element 42 could be dispensed with. A dedicated lubrication means is not obligatory for the actuation unit 26, since the relative movements which occur between the converter elements 30, 34 are comparatively low. The advantage of a “dry” clutch lies in the greater utilization of coefficient of friction and therefore in the usually lower frictional coefficient in comparison with “wet” clutches. Moreover, the basic torque behavior of “dry” clutches is usually better, since “dry” clutches can be ventilated completely. Basic torque is to be understood as the torque which is also transmitted in the non-actuated state of the torque transmission device. In the case of “wet” clutches, a certain transmission of torque takes place solely as a result of hydrodynamic effects on account of the movement of the lubricant.

LIST OF REFERENCE SIGNS

| | |
|---|---|
| 10, 10′ | Torque transmission device |
| 12 | Multiple disk clutch |
| 14 | Shaft |
| 16 | Flange |
| 18 | Clutch basket |
| 18a | Clutch basket section |
| 18b | Housing section |
| 19a, 19b | Bearing |
| 20 | Outer disk |
| 22 | Inner disk |
| 24, 24′ | Spline system |
| 26 | Actuation unit |
| 28 | Converter device |
| 30, 34 | Converter element |
| 34′ | Recess |
| 32 | Rolling body |
| 32a | Groove |
| 36 | Pilot disk |
| 38 | Electromagnet |
| 40 | Recess |
| 41 | Ramp mechanism |
| 42 | Sealing element |
| 44 | Flange |
| R | Rotational axis |
| F | Magnetic flux |
| α | Gradient |

1-13. (canceled)

14. A torque transmission device to transmit torque between a first component and a second component which are mounted to rotate about a common rotational axis, the torque transmission device comprising:
a clutch configured to actuate in an axial direction, the clutch having a structural element fixedly connected to the first component for rotation therewith; and
an actuation unit having:
a converter device with at least one axially movable first converter element and a second converter element assigned to the second component, the first and second converter elements being configured to rotate relative to one another such that a relative rotation therebetween is converted into an axial movement of the first converter element to thereby actuate the clutch; and
an actuating device configured such that a selective coupling action is generated between the first converter element and a structural element of the clutch which brings about a relative rotation of the first and second converter elements with respect to one another.

15. The torque transmission device of claim 14, wherein the actuating device comprises an electromagnet configured to generate a magnetic coupling between the first converter element and the structural element.

16. The torque transmission device of claim 15, wherein the electromagnet comprises a coil arranged coaxially with respect to the first and second components.

17. The torque transmission device of claim 14, wherein the second converter element is configured for axial connection to the second component for rotation therewith.

18. The torque transmission device of claim 14, wherein the first converter element is configured to rotate relative to the first component and the second component.

19. The torque transmission device of claim 14, wherein the first and second converter elements are configured to form a ramp mechanism which comprises at least one rolling body arranged between the first and second converter elements.

20. The torque transmission device of claim 19, wherein the first and second converter elements have a groove configured to receive the rolling body.

21. The torque transmission device of claim 19, wherein the first and second converter elements have a V-shaped groove configured to receive the rolling body.

22. The torque transmission device of claim 19, wherein the first and second converter elements have U-shaped groove configured to receive the rolling body.

23. The torque transmission device of claim 14, wherein the first component at least partially surrounds the converter device and/or the actuating device.

24. The torque transmission device of claim 14, wherein the first component covers the actuating device completely in an axial direction.

25. The torque transmission device of claim 14, wherein the first converter element has a recess which at least partially receives the actuating device.

26. The torque transmission device of claim 14, wherein the clutch comprises a dry-running, multiple disk clutch.

27. The torque transmission device of claim 25, wherein the structural element comprises:
a first frictional face configured to interact with the first converter element; and
a second frictional face configured to lie opposite to and interact with the dry-running, multiple disk clutch.

28. The torque transmission device of claim 25, wherein the structural element comprises a disk of the dry-running, multiple disk clutch.

29. The torque transmission device of claim 14, wherein the first component comprises a clutch basket of the clutch.

30. A torque transmission device to transmit torque between a first component and a second component, the torque transmission device comprising:
a clutch having a structural element connected to the first component for rotation therewith; and
an actuation unit having:
a converter device with a first converter element and a second converter element assigned to the second component, the first and second converter elements each configured to rotate relative to one another such that a relative rotation therebetween is converted into axial movement of the first converter element which actuates the clutch; and
an actuating device configured to generate selective coupling between the first converter element and the clutch which brings about rotation of the first and second converter elements.

31. The torque transmission device of claim 30, wherein the actuating device is configured to generate a magnetic coupling between the first converter element and the structural element.

32. The torque transmission device of claim 30, wherein the first and second converter elements are configured to form a ramp mechanism which comprises a rolling body arranged between the first and second converter elements.

33. The torque transmission device of claim 32, wherein the first and second converter elements have a groove configured to receive the rolling body.
